(19) United States
(12) Patent Application Publication
(10) Pub. No.: US 2013/0195067 A1
(43) Pub. Date: Aug. 1, 2013

(54) DEVICES FOR SIGNALING AN ENHANCED PHYSICAL CONTROL FORMAT INDICATOR CHANNEL

(71) Applicants: Ahmad Khoshnevis, Portland, OR (US); Shohei Yamada, Camas, WA (US)

(72) Inventors: Ahmad Khoshnevis, Portland, OR (US); Shohei Yamada, Camas, WA (US)

(73) Assignee: Sharp Laboratories of America, Inc., Camas, WA (US)

(21) Appl. No.: 13/360,630

(22) Filed: Jan. 27, 2012

(51) Int. Cl. H04W 72/04

(52) U.S. Cl. 370/330; 370/329

(57) ABSTRACT

An evolved Node B (eNB) for indicating a control format is described. The eNB includes a processor and instructions stored in memory that is in electronic communication with the processor. The eNB generates a first enhanced Control Format Indicator (eCFI) corresponding to a first enhanced Physical Control Format Indicator Channel (ePCFICH). The first eCFI at least partially indicates a first enhanced Physical Downlink Control Channel (ePDCCH) region. The eNB also loads the first eCFI into a first set of resource elements in a first slot. The eNB additionally sends the first eCFI in the first slot in a first subframe.

### TECHNICAL FIELD

The present disclosure relates generally to communication systems. More specifically, the present disclosure relates to devices for signaling an enhanced Physical Control Format Indicator Channel (ePCFICH).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may communicate with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one configuration of an evolved Node B (eNB) and one or more User Equipments (UEs) in which systems and methods for signaling an enhanced Physical Control Format Indicator Channel (ePCFICH) may be implemented;

FIG. 2 is a flow diagram illustrating one configuration of a method 200 for indicating a control format;

FIG. 3 is a flow diagram illustrating one configuration of a method 300 for determining a control format;

FIG. 4 is a block diagram illustrating one example of a slot;

FIG. 5 is a block diagram illustrating another example of a slot;

FIG. 6 is a block diagram illustrating another example of a slot;

FIG. 7 is a block diagram illustrating another example of a slot;

FIG. 8 is a block diagram illustrating several examples of ways in which consecutive resource elements may be allocated;

FIG. 9 is a block diagram illustrating examples of enhanced Physical Control Format Indicator Channel (ePCFICH) resource allocation and symbol mapping;

FIG. 10 illustrates various components that may be utilized in a User Equipment (UE); and

FIG. 11 illustrates various components that may be utilized in an evolved Node B (eNB).

### DETAILED DESCRIPTION

An evolved Node B (eNB) for indicating a control format is described. The eNB includes a processor and instructions stored in memory that is in electronic communication with the processor. The eNB generates a first enhanced Control Format Indicator (eCFI) corresponding to a first enhanced Physical Control Format Indicator Channel (ePCFICH). The first eCFI at least partially indicates a first enhanced Physical Downlink Control Channel (ePDCCH) region. The eNB also loads the first eCFI into a first set of resource elements in a first slot. The eNB further sends the first eCFI in the first slot in a first subframe. The first ePCFICH may be a first Downlink Control Information (DCI) in a common search space.

The first set of resource elements may be loaded initially across time resources and then across frequency resources in the first slot. The first set of resource elements may include a number of resource elements at a beginning of the first slot, a number of resource elements at an ending of the first slot, a dynamic cell-specific set of resource elements in the first slot, a static cell-specific set of resource elements in the first slot or a semi-static cell-specific set of resource elements in the first slot.

The eNB may interleave a first set of eCFI bits. The eNB may scramble a first set of eCFI bits with a scrambling sequence specific to a cell.

The eNB may send one or more of system information signaling, Radio Resource Control (RRC) signaling, Physical Downlink Control Channel (PDCCH) common control signaling and ePDCCH common control signaling that indicates the first set of resource elements. The eNB may signal a random frequency offset by sending Radio Resource Control (RRC) signaling.

The eNB may generate a second eCFI corresponding to a second ePCFICH. The eNB may also load the second eCFI into a second set of resource elements in a second slot in the first subframe. A first random frequency offset applied to the first ePCFICH may be separate from a second random frequency offset applied to the second ePCFICH.

The eNB may map a second ePCFICH to a second layer on the first slot. The eNB may also map the first ePCFICH to a first layer on the first slot. The first ePCFICH may not be pre-coded or the first ePCFICH may be pre-coded based on a pre-coding matrix that is common to a set of User Equipments (UEs).

The first eCFI may have a value ranging between 1 and a number. A unit of the number may be defined based on a resource block, a resource element, a set of consecutive resource elements or a fraction of a resource block. The eNB may signal the unit of the number.

A User Equipment (UE) for determining a control format is also described. The UE includes a processor and instructions stored in memory that is in electronic communication with the processor. The UE receives a first subframe. The UE also obtains a first enhanced Control Format Indicator (eCFI) corresponding to a first enhanced Physical Control Format Indicator Channel (ePCFICH). The first eCFI at least partially indicates a first Physical Downlink Control Channel (ePDCCH) region. The UE additionally determines the ePDCCH region based on the first eCFI. If the UE does not obtain a second eCFI corresponding to a second ePCFICH in a second slot, then the UE may apply parameters in the first eCFI in a first slot to the second slot.

A method for indicating a control format by an evolved Node B (eNB) is also described. The method includes generating a first enhanced Control Format Indicator (eCFI) corresponding to a first enhanced Physical Control Format Indicator Channel (ePCFICH). The first eCFI at least partially indicates a first enhanced Physical Downlink Control Channel (ePDCCH) region. The method also includes loading the first eCFI into a first set of resource elements in a first slot. The method additionally includes sending the first eCFI in the first slot in a first subframe.

A method for determining a control format on a User Equipment (UE) is also disclosed. The method includes receiving a first subframe. The method also includes obtaining a first enhanced Control Format Indicator (eCFI) corresponding to a first enhanced Physical Control Format Indicator Channel (ePCFICH). The first eCFI at least partially indicates a first Physical Downlink Control Channel (ePDCCH) region. The method additionally includes determining the ePDCCH region based on the first eCFI.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems, and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP Long Term Evolution (LTE), LTE-Advanced (LTE-A) and other standards (e.g., 3GPP Releases 8, 9, 10 and/or 11). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a User Equipment (UE), an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a User Equipment (UE). However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an evolved or enhanced Node B (eNB), a home enhanced or evolved Node B (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency band) to be used for communication between a Node B (e.g., eNodeB) and a UE. “Configured cells” are those cells of which the UE is aware and is allowed by a Node B (e.g., eNB) to transmit or receive information. “Configured cell(s)” may be serving cell(s). The UE may receive system information and perform the required measurements on all configured cells. “Activated cells” are those configured cells on which the UE is transmitting and receiving. That is, activated cells are those cells for which the UE may monitor the Physical Downlink Control Channel (PDCCH) or enhanced PDCCH (ePDCCH) and in the case of a downlink transmission, those cells for which the UE decodes a Physical Downlink Shared Channel (PDSCH) or enhanced PDSCH (ePDSCH). “Deactivated cells” are those configured cells for which the UE is not monitoring the transmitted PDCCH or ePDCCH. It should be noted that a “cell” may be described in terms of differing dimensions. For example, a “cell” may have temporal, spatial (e.g., geographical) and frequency characteristics.

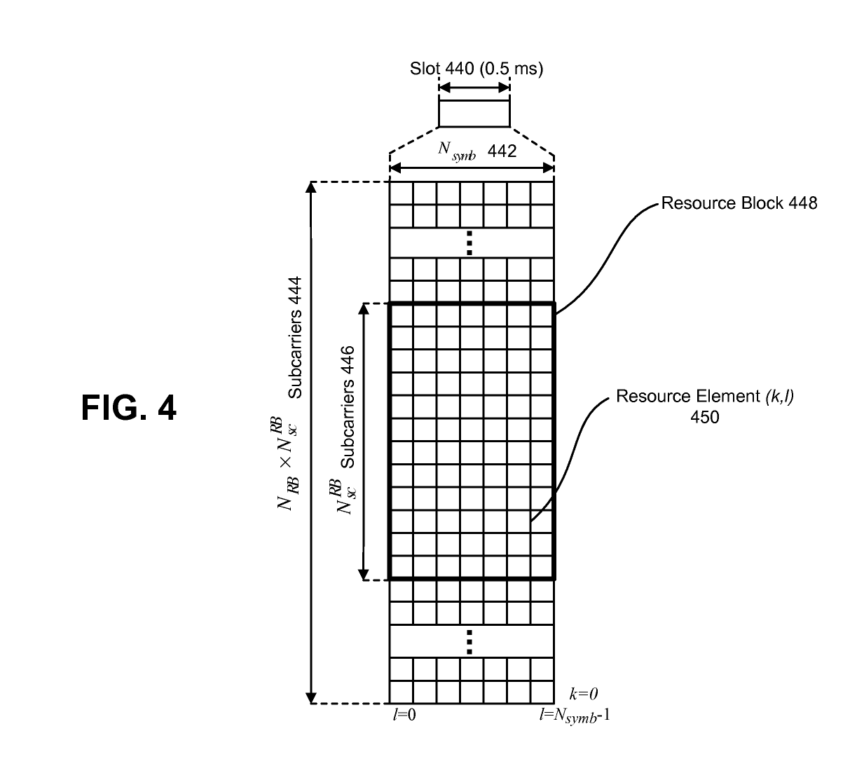

The systems and methods disclosed herein may be applied to enable dynamic addressing. In general, addressing procedures can be found in many applications such as hard disk addressing, memory addressing, home addressing, etc. In cellular LTE, there is a resource grid that is allocated per millisecond (ms) (e.g., for every 1 ms). The resources allocated in 1 ms may be referred to as one subframe. Each subframe has two slots. The resource grid of a subframe has two dimensions, time and frequency. More detail regarding the resource grid is given in connection with FIG. 4.

In the time domain, there may be 12 or 14 symbols per subframe (depending on the whether an extended or normal cyclic prefix is used). These symbols may be Orthogonal Frequency-Division Multiplexing (OFDM) symbols. In the frequency domain there may be N subcarriers. The number of subcarriers may depend on available bandwidth for communications.

In 3GPP Release 8 specifications, one, two or three OFDM symbols (depending on the payload of the control channel) may be allocated by the base station (e.g., eNB) for the transmission of a control channel known as the PDCCH (Physical Downlink Control Channel). The number of OFDM symbols allocated to the PDCCH may be signaled to the UE through another control channel known as the PCFICH (Physical Control Format Indicator Channel). The PCFICH is located on fixed resource elements on the first OFDM symbols of every downlink subframe. By receiving the PCFICH, the UE knows how many OFDM symbols are allocated for the PDCCH.

Because the amount of information transmitted to the UEs in the PDCCH are not a priori known, the UEs do not know how to decode the PDCCH. To resolve this problem, the control information is sent in packets of pre-specified length known as Downlink Control Information (DCI). Das may carry different information. For example, one DCI may be used to inform UEs about downlink resource allocation and another may be used to inform a specific UE about uplink resource allocation, etc. Thus, depending on the functionality of a DCI, different DCIs with different functionality may have different lengths. Different Das may be distinguished by the way they are formatted and coded, which may be referred to as DCI formats. It should be noted that “resource allocation” may refer to allocating one or more resource elements.

Since the UEs do not know about the downlink control information in advance, they do not know how many Das in which format are being transmitted in the downlink control channel. Therefore, the UEs may search and blindly test for all possible combination of DCIs. In order to reduce the search, the resources allocated for transmission of the downlink control channel (per UE, for example) is divided into two regions: a common search space and a UE-specific search space. The regions of the two search spaces are signaled to all UEs in advance. Accordingly, all UEs know the common search space, and each UE (only) knows its own UE-specific search space.

A “region” may be a collection of time and frequency resources. There are two regions that may be allocated for transmission of control information, namely, common control information (in the common search space) and UE-specific control information (in the UE-specific search space). Each piece of control information known as Downlink Control Information (DCI) may be transmitted in a channel known as the Physical Downlink Control Channel (PDCCH). The physical resource occupied by any given PDCCH may either be within the common region (e.g., common search space) or in the UE-specific region (e.g., UE-specific search space).

Allocating an entire OFDM symbol for control information, as in 3GPP Release 8-10 specifications, may be wasteful. For example, the base station may not have enough information to fill up an entire OFDM symbol. In this case, the empty part of the OFDM symbol allocated for a PDCCH is wasted. In order to remove this shortcoming, resources (e.g., resource elements) may be allocated in the time domain first in accordance with the systems and methods disclosed herein instead of in frequency first (e.g., along a frequency axis according to an OFDM symbol). This approach may be applied to anticipated Release 11 specifications. In other words, instead of allocating OFDM symbols for transmission of control information, the eNB may allocate subcarriers within a subframe for transmission of control information.

Accordingly, the systems and methods disclosed herein may describe several ways in which a PDCCH region may be indicated to (e.g., addressed to) a UE. In one example, a base station (e.g., eNB) may indicate a starting resource of the PDCCH and the size (e.g., length) of the PDCCH (or ePDCCH) to a UE.

The systems and methods disclosed herein may increase the flexibility of the base station for scheduling while managing the amount of overhead. For example, some parts of the information may be semi-static, such as the starting resource and/or subcarrier of the PDCCH. This may be done while other parts of the information may be signaled dynamically, such as the size (e.g., length) of the PDCCH.

A new control channel is being designed for anticipated 3GPP Release 11 specifications known as the enhanced Physical Control Channel (ePDCCH). In order to reduce UE complexity, the size as well as the boundaries of the ePDCCH may be determined (e.g., known) at the UE. Explicit signaling is used in previous releases of 3GPP specifications (e.g., Releases 8-10). However, modification to the signaling may be beneficial. The systems and methods disclosed herein provide solutions for informing the UE about the size and resources used by ePDCCH.

The systems and methods disclosed herein may provide one or more of the features given as follows. One or both slots in a subframe may each have their own enhanced (or extended) Physical Control Format Indicator Channel (ePCFICH). In some configurations, each slot may have a different random frequency offset. In the absence of an ePCFICH in the second slot of a subframe, the same parameters as given by the first ePCFICH may be assumed.

In a multiple antenna system, each layer may have a separate ePCFICH. In some configurations, the ePCFICH is not pre-coded. However, in configurations where the ePCFICH is pre-coded, it may be pre-coded with a pre-coding matrix that is common to all intended recipient UEs.

The systems and methods disclosed herein may include one or more physical resource allocation features as follows. The first K (considering redundancy) resource elements in a slot, the last K resource elements in a slot, or a dynamic, static or semi-static cell-specific set of resource elements in a slot may be allocated for transmission of the ePCFICH. In some configurations, the symbols may be loaded on the time domain first and then across the frequency (in accordance with resource elements in a resource grid, for example).

Any type of interleaver may be used to shuffle the bits or symbols around before assignment. A cell-specific scrambler may be used for scrambling the ePCFICH. In some configurations, static allocation via system information may be applied. In some configurations, semi-static or semi-dynamic allocation via Radio Resource Control (RRC) signaling may be applied. In some configurations, dynamic or semi-dynamic allocation via PDCCH or ePDCCH common control signaling may be applied. The ePCFICH may be the first Downlink Control Information (DCI) in the common search space. For instance, a new DCI may be defined for the ePCFICH.

For reducing interference, a random frequency offset may be applied. For example, the frequency offset may be indicated by a cell-specific parameter, which may be RRC signaled or may be calculated at the UE based on the Cell-ID (e.g., cell identifier, cell identity or cell identification).

The ePCFICH carries one or more enhanced Control Format Indicators (eCFIs), where each may take values between 1 and n. Accordingly, the eCFI may require y=ceiling(Log₂(n)) bits, where ceiling(a) is a function that returns the smallest integer larger than a. n may have one or more of the following units or dimensions: a resource block, a resource element, a group of x consecutive resource elements and a fraction of a resource block (e.g., ½ or ⅓). In some configurations, the unit or dimensions for n may vary in a semi-static way (through RRC signaling, for example).

A resource grid in a time slot may be arranged as follows. The resource elements within a resource block are indexed as (k,l), where k is the index of the subcarrier in the frequency domain and l is the index of the Orthogonal Frequency-Division Multiplexing (OFDM) symbol in the time domain. More detail on the resource grid is given in connection with FIG. 4 below.

In Releases 8-10 in the downlink, the first one, two or three OFDM symbols are dynamically allocated for transmission of a physical downlink control channel (PDCCH). Information regarding the number of OFDM symbols dedicated for the PDCCH is carried in the physical control format indicator channel (PCFICH). The PCFICH carries two bits of information that are referred to as a Control Format Indicator (CFI). The CFI indicates whether there are one, two or three OFDM symbols allocated for the PDCCH. A UE may first decode the PCFICH to determine the format of the PDCCH. The UE may then attempt to search for Downlink Control Information (DCI) in the PDCCH.

In particular, one procedure for receiving and decoding a PCFICH and a PDCCH is given as follows. A UE may receive a PCFICH. The UE may decode the PCFICH to determine the value of a CFI. The CFI may indicate the size of the PDCCH and the way that Das are mapped into the PDCCH. The UE may search the common search space in the PDCCH to determine or identify common control information. The UE may also search the UE-specific search space to determine or identify portions of the PDCCH or Das that correspond specifically to the UE.

The systems and methods disclosed herein describe an enhanced (or extended) PDCCH referred to as an ePDCCH that may be applied to anticipated Release 11 specifications (and possibly beyond). In an ePDCCH, the entirety of an OFDM symbol may not be dedicated to control channel information, unlike in Release 8-10 specifications. A dedicated component carrier known as an extension carrier may be applied specifically to Release 11 UEs. In other words, the extension carrier may not be backwards compatible with legacy UEs (e.g., UEs that operate in accordance with Release 8-10 specifications). In another configuration, the ePDCCH may be transmitted in a component carrier that also supports transmission of the PDCCH.

In some configurations, the ePDCCH may extend through all the symbols in the time domain (in a slot, for example) but may not extend through all the subcarriers in the frequency domain. Depending on the payload of the control the size of the ePDCCH (e.g., the number of resource elements occupied by the ePDCCH), the number of subcarriers allocated to the ePDCCH may vary. It may be beneficial for all UEs that attempt to decode the ePDCCH to know the region (e.g., the boundaries of the region) allocated to the ePDCCH. Knowing the ePDCCH region can determine the amount of blind decoding and the arrangement of Downlink Control Information (DCI) in the ePDCCH. The ePDCCH may be determined based on the content of the enhanced (or extended) Physical Control Format Indicator Channel (ePCFICH). The content of the ePCFICH may be referred to as an enhanced (or extended) Control Format Indicator (eCFI). For clarity, the ePCFICH is a channel and the information content that is carried through the ePCFICH may be referred to as the eCFI.

If the ePDCCH is allocated such that there is one contiguous Physical Downlink Shared Channel (PDSCH), or enhanced (or extended) PDSCH (ePDSCH), then the ePDCCH region may also be determined by the starting point of the PDSCH or ePDSCH. However, if the ePDCCH divides the PDSCH or ePDSCH into two disjoint partitions, then the starting point of PDSCH or ePDSCH may not (by itself) determine the ePDCCH region. It should be noted that the term ePDSCH may be used to refer to a shared channel that is linked to (e.g., associated with) the ePDCCH. Accordingly, there may be a distinction between the downlink resources (e.g., PDSCH) that are addressed by or linked to the PDCCH, and the downlink resources (e.g., ePDSCH or a subset of the PDSCH, which may be denoted herein as an ePDSCH) that are addressed by or linked to the ePDCCH. The systems and methods disclosed herein may thus provide a benefit of flexibly referring to ePDCCH resources, and therefore referring indirectly to ePDSCH resources. For example, the systems and methods disclosed herein may allow flexible indication and/or determination of ePDCCH resources and ePDSCH resources.

The ePDCCH contains independent packets (e.g., packets that can be decoded separately without any dependency on other packets in the ePDCCH) that contain (and may be referred to as) Downlink Control Information (DCI). The ePDCCH may be divided into two regions: a common region and a UE-specific region. The common region carries control information concerning all UEs, whereas the UE-specific region carries control information that is specific to a particular UE. Each UE may search the common region (referred to as common search space) and a UE-specific region (referred to as UE-specific search space) in order to find relevant control information carried in different DCI.

Each DCI may have a plurality of formats that is not known to the UEs a priori. Accordingly, the UE may attempt to decode each DCI for all permissible DCI formats (which may be a subset of all DCI formats). The procedure of decoding a received DCI based on multiple format parameters may be referred to as blind decoding. The set of permissible DCI formats may be a function of the location of the DCI in the search space (e.g., common search space versus UE-specific search space) and/or the size of the DCI. In some approaches, the ePDCCH region may be determined by identifying the number of blind decoding candidates that each UE must search or the maximum number of blind decoding candidates for search among all UEs that are receiving the ePDCCH.

Thus, the systems and methods disclosed herein present several approaches for identifying the ePDCCH region. In one approach, the ePDCCH may be identified by obtaining (e.g., knowing) the starting (or ending) point of ePDCCH (e.g., the first (or last) resource element allocated to the ePDCCH) and the size of the ePDCCH (in terms of the number of resource elements, for example). In another approach, the ePDCCH may be identified by obtaining (e.g., knowing) the starting (or ending) point of ePDCCH (e.g., the first or last resource element allocated to the ePDCCH) and a number of blind decoding candidates for a given UE to search or a maximum number of blind decoding candidates for searches to be performed by all UEs receiving the ePDCCH. In yet another approach, in a case where the ePDSCH is one contiguous region, the ePDCCH may be identified by obtaining (e.g., knowing) the starting point (or the ending point) of the ePDSCH (e.g., the first resource element or the last resource element), allocated to the ePDSCH. It should be noted that in an alternative approach, a static or a semi-static region may be allocated for the ePDCCH. However, this is not the focus of the systems and methods disclosed herein, but is mentioned for the sake of completeness.

More detail on each of the approaches for identifying the ePDCCH region is given hereafter. One approach that is based on obtaining (e.g., knowing) the starting (or ending) point of an ePDCCH (e.g., the first or last resource element allocated to ePDCCH) and the size of ePDCCH (in terms of the number of resource elements, for example) is described in additional detail as follows.

In this approach, two parameters may be obtained in order to identify the ePDCCH region. One parameter is the starting (or ending) point of ePDCCH. The other parameter is the size of the ePDCCH. Each of these parameters may be configured statically, semi-statically or dynamically.

In static configuration, the parameter is sent to the UE (from an eNB) through broadcasting system information. In semi-static configuration, the parameters are sent to the UE (from an eNB) through dedicated RRC signaling. In dynamic configuration, the parameters are sent to the UE (from an eNB) through non-data channels in every downlink subframe (in a PCFICH or ePCFICH, for example). In some configurations, in a case where multiple (non-contiguous) regions are allocated to the ePDCCH, multiple starting points and multiple sizes may be signaled by the eNB to the UE.

Within the current approach, one (or more) of several cases may be implemented. In one case, the starting (or ending) point may be configured statically by system information. Additionally, the size of the ePDCCH may be configured statically (where system information carries the value of the size of the ePDCCH, for example), semi-statically (where RRC signaling sets the value of the size of the ePDCCH, for example) or dynamically (where an eCFI carries the value of the size of the ePDCCH, for example).

In another case, the starting (or ending) point may be configured semi-statically by RRC signaling. Additionally, the size of the ePDCCH may be configured semi-statically (where RRC signaling sets the value of the size of the ePDCCH, for example), dynamically (where an eCFI carries the value of the size of the ePDCCH, for example) or statically (through transmission of system information, for example).

In another case, both the starting (or ending) point and the size of the ePDCCH may be configured dynamically. In this case, the eCFI contains both the starting (or ending) point and the size of the ePDCCH.

In another case, the size of the ePDCCH may be configured statically. Additionally, the starting (or ending) point may be configured semi-statically (where RRC signaling sets the value of starting (or ending) point of the ePDCCH), or dynamically (where the eCFI carries the value of the starting (or ending) point of the ePDCCH).

In some configurations, whether a starting point or an ending point is used for determining the size of the ePDCCH is fixed and known (without any need for signaling) to all UEs. Alternatively, it can be set statically (via system information signaling) or semi-statically (via RRC signaling). However, this may incur extra overhead and may offer a limited benefit, if any, in explicit signaling.

There are several ways to indicate the size of ePDCCH in accordance with the systems and methods disclosed herein. The size of ePDCCH can be expressed in terms of one of several units. In one configuration, the size of the ePDCCH may be indicated in consecutive resource elements. For example, assuming that the size of the ePDCCH is n, the ePDCCH includes n consecutive resource elements. In another configuration, the size of the ePDCCH may be indicated as a set of m (e.g., group of m) consecutive resource elements. For example, assuming that the size of the ePDCCH is n, the ePDCCH includes n×m consecutive resource elements.

In another configuration, the size of the ePDCCH may be indicated as consecutive resource blocks. For example, assuming that the size of the ePDCCH is n, the ePDCCH includes n consecutive resource blocks. In yet another configuration, the size of the ePDCCH may be indicated as fractions of a resource block (e.g., p/q of a resource block, where p and q are natural numbers, {1, 2, . . . }). For example, assuming that the size of the ePDCCH is n, a total of n×p/q of resource blocks are allocated for the ePDCCH. For instance, n=5, p=1, and q=3 indicates an ePDCCH size of 5/3 times a resource block, which is one complete resource block and ⅔ of a resource block.

In some configurations, the unit used for describing the size of the ePDCCH can be fixed a priori without any need for signaling. Alternatively, the unit used may be configured semi-statically or statically. For example, semi-static configuration of the unit used for determining the size of ePDCCH can be achieved through RRC signaling. In another example, static configuration of the unit used for determining the size of ePDCCH can be achieved through transmission of system information, which is received by all UEs (in a cell, for example).

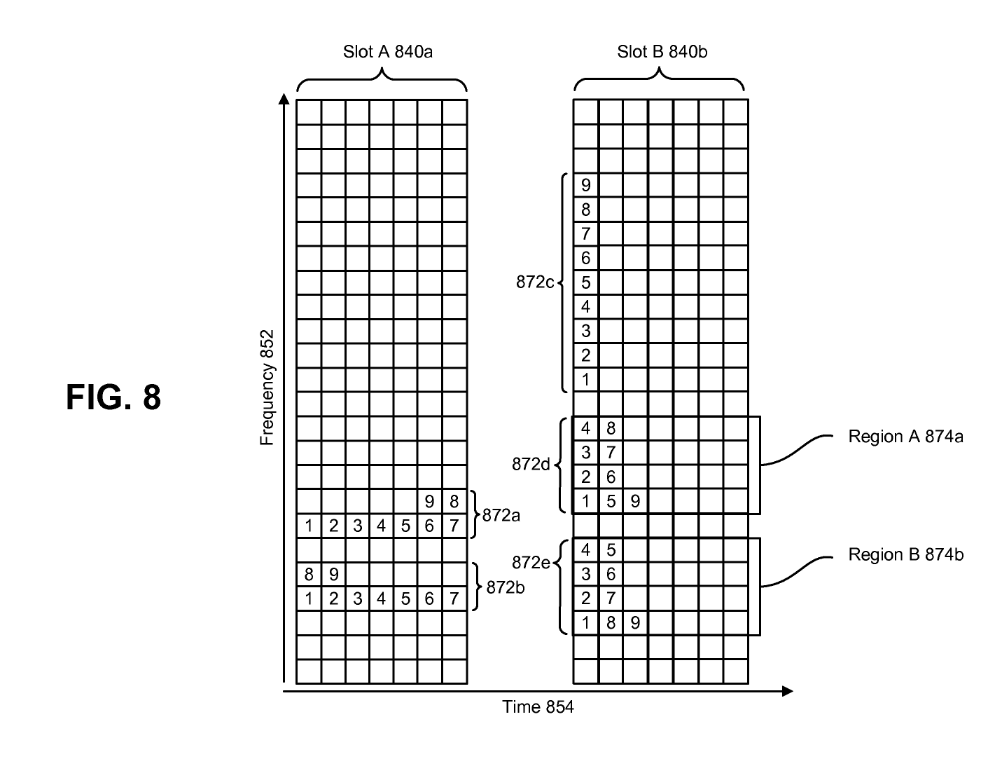

There are several ways to allocate a number of consecutive resource elements in accordance with the systems and methods disclosed herein. More detail on approaches to allocating a number of consecutive resource elements is given below in connection with FIG. 8 below. In particular, FIG. 8 depicts several ways that nine consecutive resource elements may be allocated.

An approach that is based on obtaining (e.g., knowing) the starting point of an ePDCCH (e.g., the first resource element allocated to the ePDCCH) and the number of blind decoding candidates for a given UE or a maximum number of blind decoding candidates to be performed by all UEs receiving the ePDCCH is described in greater detail as follows. In this approach, two parameters may be obtained in order to identify the ePDCCH region. One parameter is the starting (or ending) point of the ePDCCH. The other parameter is a number of blind decoding candidates.

The number of blind decoding candidates for search (e.g., the number of candidates for blind decoding or simply the number of candidates) may be UE-specific or cell-specific. If the number of blind decoding candidates is UE-specific, then the value of the number of blind decoding candidates may vary from UE to UE. If the number of blind decoding candidates is cell-specific, then the value of the number of blind decoding candidates is the same for all UEs (in a cell, for example).

If the number of blind decoding candidates is cell-specific, then the value can be decided based on a maximum possible number of blind decoding candidates in a static or semi-static configuration. If the number of blind decoding candidates is cell-specific, then the value can be decided alternatively based on a maximum number of blind decoding candidates among UEs that are receiving the ePDCCH in a given subframe for dynamic configuration.

Within the current approach, one (or more) of several cases may be implemented. In one case, the starting (or ending) point may be configured statically by system information. Additionally, the number of blind decoding candidates of the ePDCCH may be configured statically (where system information carries the value of the number of blind decoding candidates of the ePDCCH, for example), semi-statically (where RRC signaling sets the value of the number of blind decoding candidates of the ePDCCH, for example) or dynamically (where the eCFI carries the value of the number of blind decoding candidates of the ePDCCH, for example).

In another case, the starting (or ending) point may be configured semi-statically by RRC signaling. Additionally, the number of blind decoding candidates of the ePDCCH may be configured semi-statically (where RRC signaling sets the value of the number of blind decoding candidates of the ePDCCH, for example, dynamically (where an eCFI carries the value of the number of blind decoding candidates of the ePDCCH, for example) or statically (through transmission of system information, for example).

In another case, both the starting (or ending) point and the number of blind decoding candidates of the ePDCCH may be configured dynamically. In this case, the eCFI contains both the starting (or ending) point and the size of the ePDCCH.

In another case, the number of blind decoding candidates of the ePDCCH may be configured statically. Additionally, the starting (or ending) point may be configured semi-statically (where RRC signaling sets the value of starting (or ending) point of ePDCCH, for example) or dynamically (where an eCFI carries the value of the starting (or ending) point of the ePDCCH, for example).

An approach where the ePDSCH is one contiguous region that is based on obtaining (e.g., knowing) the starting point (or the ending point) of the ePDSCH (which may be the first resource element (or the last resource element), allocated to ePDSCH, for instance) is described in additional detail as follows. In this approach, the starting (or the ending) point of the ePDSCH may be signaled statically (where system information carries the starting (or ending) point of the ePDSCH, for example) semi-statically (via RRC signaling, for example) or dynamically (where the eCFI determines the starting (or the ending) point of ePDSCH, for example).

Some approaches for physical resource allocation for the ePCFICH in accordance with the systems and methods disclosed herein are described as follows. In these approaches, the size of the ePDCCH is denoted by n (which may have one of the units described above), the number of resource elements in one unit of the ePDCCH is denoted by n1 and the total number of resource elements in one slot by is denoted by n2.

The size of the ePDCCH, n, may have a value between 0 and n3=ceiling(n2/n1), where ceiling(a) is a function that returns the smallest integer larger than a. In order to represent n, a maximum of n4=Log₂(n3) bits is needed. A coding rate of r=n4/n5 may be used, where n5 is the number of coded bits. The n5 coded bits may be used to generate n6 bits of cyclic redundancy check (CRC) code. The n6 CRC bits may be scrambled by a cell-specific scrambler. The cell-specific scrambler may be a function of cell-ID. For example, a cell-specific Radio Network Temporary Identifier (RNTI), such as Paging RNTI (P-RNTI), Random Access RNTI (RA-RNTI), system information RNTI (SI-RNTI) or a group Cell RNTI (C-RNTI) may be used for scrambling the ePCFICH CRC code. The total number of bits transmitted on the ePCFICH may be n7=n5+n6. An interleaver may be used to shuffle the transmitted bits. If every n8 bits are used to generate one modulated symbol, and if each modulated symbol occupies one resource element, then a total of n9=n7/n8 resource elements may be needed for transmission of the ePCFICH. The coding used for encoding the n4 uncoded bits may be a convolutional code or simply a repetition code (in which the uncoded bits are repeated multiple times, for example).

The physical resources allocated for transmission of ePCFICH may be the first, the last, or a pre-specified n9 resource elements within a slot. The location of the ePCFICH may be configured semi-statically or statically. Semi-static configuration of the location of the ePCFICH may be achieved through RRC signaling. Static configuration of the location of ePCFICH may be achieved through transmission of system information, which is received by all UEs (in a cell, for example). A cell-specific frequency offset may be used to reduce the collision of ePCFICH of adjacent cells.

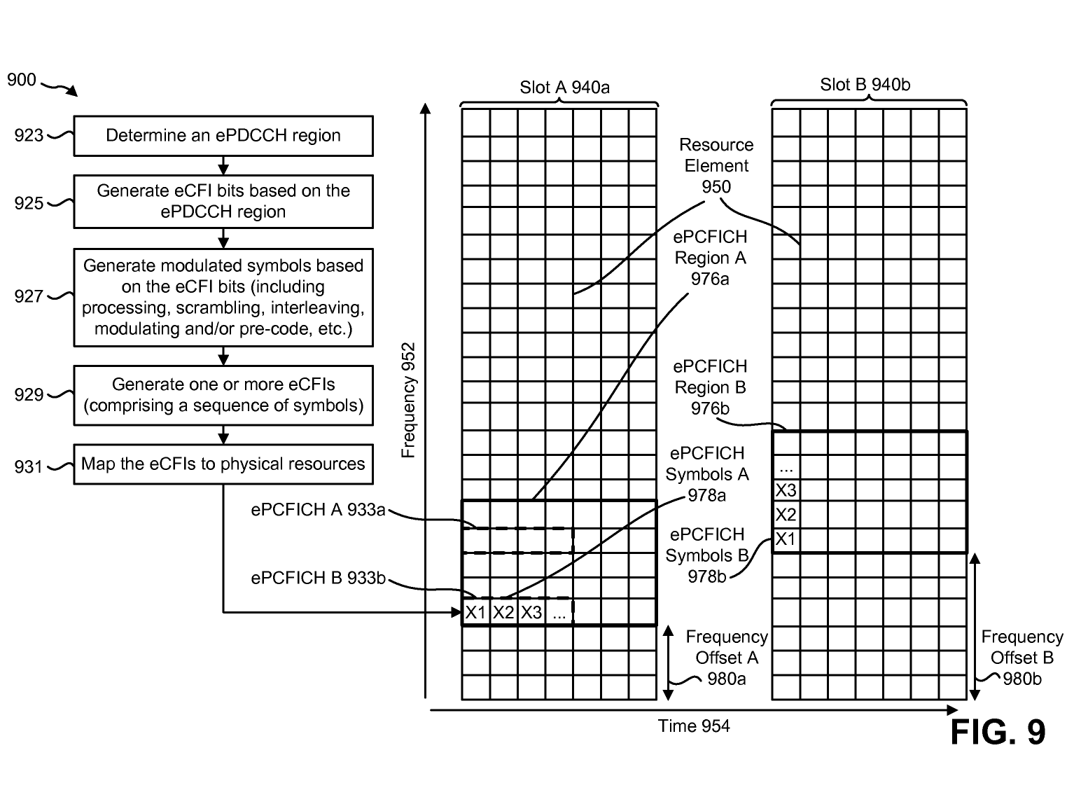

In some configurations of the systems and methods disclosed herein, symbol mapping in the ePCFICH region may be performed as follows. In one approach, symbols may be mapped along a time axis first. In another approach, symbols may be mapped along a frequency axis first. In either approach, if the ePCFICH symbols cannot fill up the whole ePCFICH region, the remaining unfilled resource elements may be filled with dummy symbols (possibly representing Os, which may be referred to as zero-padding). More detail is given in connection with FIG. 9 below.

If multiple antennas are used at the transmitter and receiver and multi-layer transmission is supported, each layer may have its own ePDCCH. Furthermore, ePDCCHs on different layers may have different sizes and occupy different resources on the resource grid. Accordingly, each layer may have its own ePCFICH in some configurations. In other configurations or instances, the ePCFICH on one layer (e.g., on a first layer) may indicate ePDCCH allocations on all layers. For example, an eNB may send information in a first ePCFICH on a first layer to indicate ePDCCH allocations on a first layer and one or more additional layers. Accordingly, in some configurations or instances, a UE may follow the ePCFICH on the first layer in determining the ePDCCH allocations on the first layer and one or more additional layers. In some cases, an ePCFICH may only be sent on one (e.g., a first) layer. In some configurations, the ePCFICH on each layer may not be pre-coded so that all UEs can receive and decode it. In other configurations, if one or more ePCFICHs are pre-coded, then a pre-coding matrix may be used that is known to all of the intended recipient UEs.

There are two slots in each subframe (in each layer), which may be referred to as a first slot and a second slot. Each slot may have its own ePDCCH. Furthermore, the ePDCCH on the first slot may have a different size than the ePDCCH on the second slot. Accordingly, each slot may have its own ePCFICH that is used to indicating the size of ePDCCH on that slot. If the second slot in a subframe (on the same layer) does not carry an ePCFICH, the parameters of the ePCFICH of the first slot may be assumed for the second slot (regarding the size of the ePDCCH on the second slot). Each slot may have its own cell-specific frequency offset.

Having a different ePCFICH on each slot may increase the efficiency of resource usage. Also, using a different ePCFICH on each layer may allow ePDCCHs of different sizes on each layer, which may be used for grouping UEs, for providing more flexible scheduling and for more efficient resource usage.

For clarity, several items should be noted, which are given as follows. The systems and method disclosed herein may enable “resource allocation” which may comprise identifying resource elements on the resource grid. This may be done (on an eNB) after generating a bitstream which is involved in allocating time, frequency and/or spatial physical resources for transmission of the bitstream.

Some configurations of the systems and method disclosed herein may allow a particular approach to resource allocation. More specifically, some configurations enable dynamic resource allocation for the ePCFICH. It should be noted that “dynamical” allocation in 3GPP specifications may be performed via the physical control channel. In one configuration enables dynamic resource allocation via a PDCCH. It should be noted that the PDCCH may be a legacy solution that was proposed in Release 8 specifications. Therefore, the PDCCH may be transmitted in some configurations or instances for supporting legacy UEs (for backwards compatibility). In one configuration, Release 11 UEs may determine the location (resources allocated) of an ePCFICH from the PDCCH.

The ePDCCH, similar to the PDCCH, may be divided in two sections. A first region may include resources allocated for transmission of downlink control information and may be dedicated to “common control information,” which is shared among all UEs (in a cell, for example). It contains control information that is received by all UEs. A second region may be a UE-specific region. In configurations where dynamic resource allocation for ePCFICH can be done by ePDCCH common control signaling, it may be assumed that the region allocated for common control in the ePDCCH is known to all UEs and all UEs can access the region and obtain the common control information. In this case, one piece of the information may indicate the resources allocated for ePCFICH.

Some configurations described herein may enable indication to a UE about the physical resources allocated to ePCFICH. Some of the configurations may be static and implicit (e.g., a static allocation of K resource elements for the ePCFICH). Other configurations provide explicit indications with different delay tolerances. Semi-static methods may require a longer time to be changed or updated, whereas dynamic allocation may be relatively faster. The actual resource allocation may be performed at the eNB and scheduler (in the semi-static and dynamic cases, for example) and the allocation may be conveyed (e.g., indicated) to the UE. The act of informing the UE of the allocated resources may sometimes also be referred to as resource allocation.

It should be noted that the ePCFICH may be considered a separate channel from the ePDCCH. It should also be noted that the UE-specific search space may only be known to a specified UE and not all UEs.

In some configurations, the UE may first recover the ePCFICH. The ePCFICH may carry the eCFI. The eCFI information packet may indicate the common and possibly UE-specific search spaces.

In some configurations, the UE may not recover the ePCFICH from the search spaces. However, in other configurations, the resources allocated to ePCFICH may be recovered from the common search space (assuming that the resources allocated to common search space is either fixed or a priori known, for example).

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

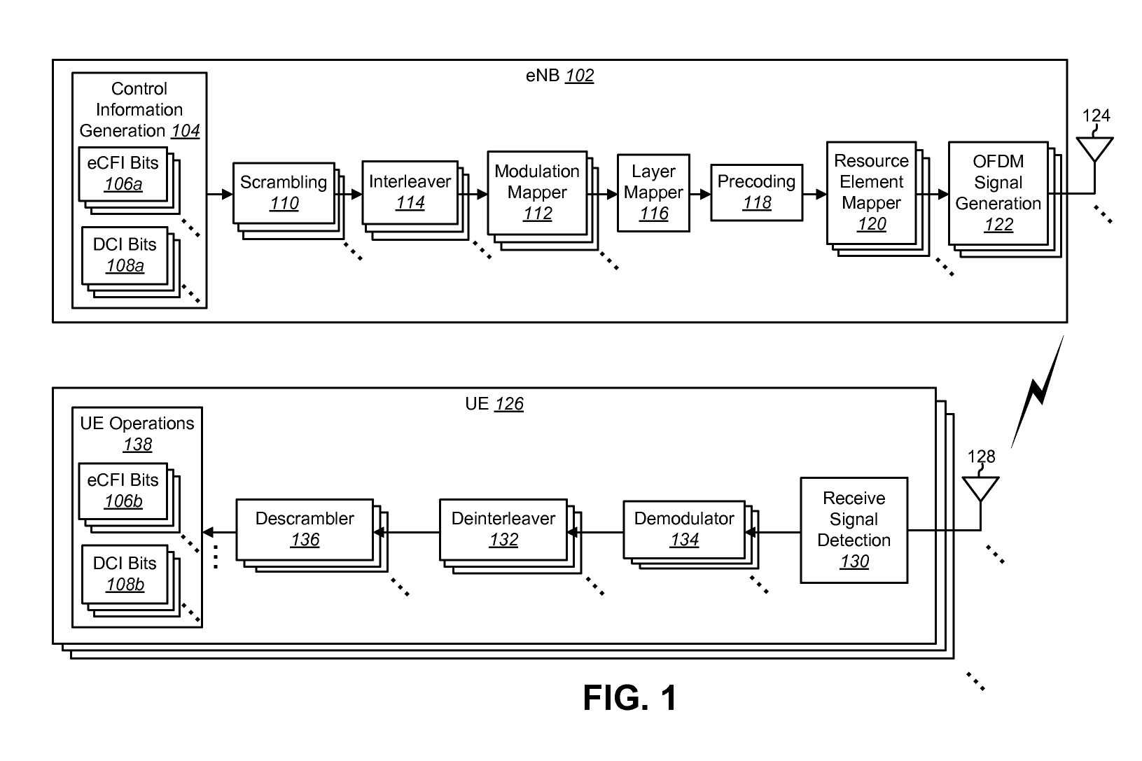

FIG. 1 is a block diagram illustrating one configuration of an evolved Node B (eNB) 102 and one or more User Equipments (UEs) 126 in which systems and methods for signaling an enhanced Physical Control Format Indicator Channel (ePCFICH) may be implemented. The eNB 102 may include one or more of a control information generation module 104, one or more scrambling modules 110, one or more modulation mappers 112, one or more interleavers 114, a layer mapper 116, a pre-coding module 118, one or more resource element mappers 120, one or more Orthogonal Frequency-Division Multiplexing (OFDM) signal generation modules 122 and one or more antennas 124.

It should be noted that one or more of the elements depicted as included within the eNB 102 may be implemented in hardware, software or a combination of both. For example, the control information generation module 104 may be implemented in hardware, software or a combination of both. It should also be noted that one or more of the elements depicted as included within the eNB 102 may be optional. For example, the one or more scrambling modules 110, the one or more interleavers 114, the layer mapper 116 and/or the pre-coding module 118 may be optional, depending on the implementation of the eNB 102. It should also be noted that the eNB 102 may include one or more signal paths between the control information generation module 104 and the one or more antennas 124.

The control information generation module 104 may generate control information to send to the one or more UEs 126. In general, control information may be used to enable communications between the eNB 102 and the one or more UEs 126. For example, control information may indicate scheduling, (communication) resource allocation, etc., to enable communication between the eNB 102 and the one or more UEs 126.

The control information generation module 104 may generate control information about the resources allocated for an ePDCCH (e.g., an ePDCCH region). This control information (about an ePDCCH region) may include one or more sets of enhanced Control Format Indicator (eCFI) bits 106a. eCFI bits 106a may be bits that are used to generate one or more eCFIs. For example, an eCFI may include information based on eCFI bits 106a (that have been scrambled, interleaved, modulated, pre-coded, grouped and/or otherwise processed, for example) that indicate the location of an ePDCCH or ePDCCH region. An eCFI may be the name of a packet that is carried over a channel referred to as an ePCFICH using the physical resources allocated on a time-frequency grid. More detail concerning the time-frequency or resource grid is given in connection with FIG. 4 below. The one or more eCFIs may partially or fully indicate one or more ePDCCH regions.

It should be noted that the control information generation module 104 may generate other control information that may be sent via one or more types of signaling (e.g., system information or static signaling, RRC or semi-static signaling, etc.). In some cases, this other control information may partially indicate one or more ePDCCH regions. In some configurations, for example, control information sent via system information or RRC signaling may be used in combination with one or more eCFIs (sent via dynamic signaling, for example) to indicate one or more ePDCCH regions.

The control information generation module 104 may additionally or alternatively generate downlink control information (DCI) bits 108a. DCI bits 108a may be bits that are used to generate one or more DCIS. For example, a DCI may include information based on DCI bits 108a (that have been scrambled, interleaved, modulated, pre-coded, grouped and/or otherwise processed, for example). Each DCI is carried over a channel referred to as the ePDCCH using the physical resources allocated for transmission of ePDCCH, which may be indicated or identified by an eCFI.

Each eCFI may have a value ranging between 1 and a number n. Depending on the implementation, the unit (e.g., units or dimensions) of n may be based on a resource block, a resource element, a set (of m) consecutive resource elements or a fraction of a resource block as described above. In some implementations, the unit for n may vary in a semi-static way. For example, the eNB 102 may generate Radio Resource Control (RRC) signaling that specifies the unit of n to the one or more UEs 126.

The control information generated by the control information generation module 104 may include eCFI bits 106a. One or more eCFIs based on the eCFI bits 106a may correspond to one or more ePCFICHs. For example, the eNB 102 may send one or more eCFIs over one or more corresponding ePCFICHs. Additionally or alternatively, the control information may include DCI bits 108a. The control information may be optionally provided to the one or more scrambling modules. The control information may optionally be scrambled by the one or more scrambling modules 110. The one or more scrambling modules 110 may scramble the control information (e.g., a set of bits) specific to a cell. For example, the one or more scrambling modules 110 may scramble the control information with a scrambling sequence that is specific to a particular cell.

The (optionally scrambled) control information may be optionally provided to one or more interleavers 114. The one or more interleavers 114 may optionally shuffle the control information (e.g., a set of bits or symbols). It should be noted that the one or more interleavers 114 may be placed in a different order in the signal path than is illustrated in FIG. 1.

The (optionally interleaved and/or scrambled) control information may be provided to one or more modulation mappers 112. The one or more modulation mappers 112 may map the control information to constellation points based on a particular modulation scheme (e.g., Quadrature Amplitude Modulation (QAM), 64-QAM, Binary Phase Shift Keying (BPSK), Quadrature Phase Shift Keying (QPSK), etc.).

The (modulated) control information (e.g., symbols) may be optionally provided to a layer mapper 116. The layer mapper 116 may optionally map the control information to one or more layers (for transmission on one or more spatial streams, for example). It should be noted that in some multiple-antenna 124 implementations, each layer may have a separate ePCFICH. For example, the layer mapper 116 may map control information corresponding to separate ePCFICHs to separate layers.

The (optionally layer-mapped) control information may be optionally provided to the pre-coding module 118. The pre-coding module 118 may optionally pre-code the control information. In an implementation where ePCFICH control information (e.g., control information corresponding to an ePCFICH) is pre-coded, for example, the pre-coding module 118 may pre-code the ePCFICH control information with a pre-coding matrix that is common to a set of UEs 126 (e.g., all intended recipient UEs 126). In other implementations, the ePCFICH control information may not be pre-coded. It should be noted that the term “set” may be used herein to denote one or more of a particular entity. For example, a set of UEs may include one or more UEs, a set of resource elements may include one or more resource elements, etc.

The (optionally pre-coded) control information may be provided to one or more resource element mappers 120. A resource element mapper 120 may map the control information to one or more resource elements. A resource element may be an amount of time and frequency resources on which information may be carried (e.g., sent and/or received). For example, one resource element may be defined as a particular subcarrier in an OFDM symbol for a particular amount of time. Greater detail on resource elements is given below.

In some configurations, each resource element may carry one modulated symbol. Accordingly, the number of bits carried in a resource element may vary. For example, each BPSK symbol carries one bit of information. Thus, each resource element that carries a BPSK symbol carries one bit. Each QPSK symbol carries two bits of information. Thus, a resource element that carries a QPSK symbol carries two bits of information. Similarly, a resource element carrying a 16-QAM symbol carries four bits of information and a resource element carrying a 64-QAM symbol carries six bits of information.

A number of resource elements may constitute a resource block. A number of resource elements (and a number of resource blocks, for example) may constitute a slot. A slot may be defined according to an amount of time. For instance, a slot may occupy 0.5 milliseconds (ms). Two slots may constitute a subframe. A number of subframes (e.g., 10) may constitute one radio frame.

The one or more resource element mappers 120 may map ePCFICH control information to resource elements within a slot. In some instances, each slot may include a separate ePCFICH. However, in other instances, not all slots may include an ePCFICH. In some implementations, when an ePCFICH is included in a first slot in a subframe but not in a second slot of the subframe, this may indicate that the parameters (e.g., eCFI) given by the ePCFICH in the first slot also apply to the second slot. In some implementations, each ePCFICH in different slots may have a separate (e.g., different) random frequency offset.

The one or more resource element mappers 120 may load control information corresponding to an ePCFICH (e.g., one or more eCFIs) into a set of resource elements in a slot. Some examples of the set of resource elements may include a number of K resource elements at the beginning (e.g., the first K resource elements) of the slot, a number of K resource elements at the ending (e.g., the last K resource elements) of the slot, a dynamic cell-specific set of resource elements in the slot, a static cell-specific set of resource elements in the slot and a semi-static cell-specific set of resource elements in the slot.

More generally, the bits generated by the eNB 102 may be scrambled and/or interleaved. After optional scrambling and/or interleaving they may be mapped into modulation symbols. Each symbol may then be loaded into a resource element.

In some implementations, the control information corresponding to an ePCFICH (e.g., a set of symbols) may be loaded initially across time resources on resource elements of a given subcarrier and then across frequency resources in the slot. More specifically, the set of symbols corresponding to an ePCFICH may be loaded into resource elements across time on a particular subcarrier if and until reaching the last resource element on that subcarrier. If more symbols corresponding to the ePCFICH remain, then they may be loaded across the time domain on another subcarrier and so forth.

The (resource-mapped) control information may be provided to one or more OFDM signal generators 122. The one or more OFDM signal generators 122 may generate OFDM signals based on the (resource-mapped) control information for transmission. The OFDM signals generated by the one or more OFDM signal generators 122 may be provided to the one or more antennas 124 for transmission to the one or more UEs 126. Thus, the eNB 102 may accordingly send control information (e.g., one or more eCFIs) on an ePCFICH. For example, the eNB 102 may send ePCFICH control information in a slot in a subframe.

In some implementations, the eNB 102 may indicate (e.g., allocate) resource elements for ePCFICH control information using certain types of signaling. In one example, the eNB 102 may indicate the location of an ePCFICH (e.g., an ePCFICH region) statically by sending a system information signal. In another example, the eNB 102 may indicate the location of an ePCFICH (e.g., an ePCFICH region) semi-statically or semi-dynamically by sending an RRC signal. In yet another example, the eNB 102 may indicate the location of an ePCFICH (e.g., an ePCFICH region) dynamically or semi-dynamically by sending PDCCH or enhanced PDCCH (ePDCCH) common control signaling.

In some implementations, ePCFICH control information may be located in a common search space. For example, the ePCFICH control information may be the first DCI in the common search space. A new DCI may be defined to accommodate the ePCFICH control information for such an implementation.

The one or more UEs 126 may include one or more of a UE operations module 138, one or more descramblers 136, one or more demodulators 134, one or more deinterleavers 132, a receive signal detection module 130 and one or more antennas 128. It should be noted that one or more of the elements depicted as included within the UE 126 may be implemented in hardware, software or a combination of both. For example, the UE operations module 138 may be implemented in hardware, software or a combination of both. It should also be noted that one or more of the elements depicted as included within the UE 126 may be optional. For example, the one or more descramblers 136 and the one or more deinterleavers 132 may be optional, depending on the implementation of the UE 126. It should also be noted that the UE 126 may include one or more signal paths between the one or more antennas 128 and the UE operations module 138.

The receive signal detection module 130 may utilize the one or more antennas 128 to receive signals from the eNB 102. For example, the receive signal detection module 130 may receive OFDM signals sent from the eNB 102.

The received signals may be provided to one or more demodulators 134. The one or more demodulators 134 may demodulate the signals to produce bits. The received signals may be optionally provided to one or more deinterleavers 132. The one or more deinterleavers 132 may optionally deinterleave (e.g., unshuffle) the bits. The bits may be optionally provided to one or more descramblers 136. The one or more descramblers 136 may optionally descramble the bits.

The (optionally deinterleaved and/or descrambled) bits may be provided to the UE operations module 138. The UE operations module 138 may obtain one or more sets of eCFI bits 106b (that are based on eCFIs generated by and sent from the eNB 102, for example) corresponding to one or more ePCFICHs.

An ePCFICH may occupy a set of resource elements in a slot. Some examples of the set of resource elements may include a number of K resource elements at the beginning (e.g., the first K resource elements) of the slot, a number of K resource elements at the ending (e.g., the last K resource elements) of the slot, a dynamic cell-specific set of resource elements in the slot, a static cell-specific set of resource elements in the slot and a semi-static cell-specific set of resource elements in the slot. For instance, control information (e.g., one or more eCFIs) corresponding to the ePCFICH may be obtained from one of these locations. In some implementations, the control information corresponding to an ePCFICH may be located initially across time resources and then across frequency resources in the slot.

In some implementations, the UE 126 may determine a location of resource elements corresponding to an ePCFICH (e.g., an ePCFICH region) based on certain types of signaling. In one example, the UE 126 may determine the ePCFICH region based on a system information signal received from the eNB 102. In another example, the UE 126 may determine the ePCFICH region based on an RRC signal received from the eNB 102. In yet another example, the UE 126 may determine the ePCFICH region based on PDCCH or ePDCCH common control signaling received from the eNB 102.

In some implementations, information corresponding to an ePCFICH may be located in a common search space. For example, the ePCFICH control information may be the first DCI in the common search space. A new DCI may be defined to accommodate the ePCFICH for such an implementation.

One or more slots received by the UE 126 may include a separate ePCFICH. In some cases, each ePCFICH may have a separate (e.g., different) random frequency offset. When there is no ePCFICH in the second slot of a subframe, the UE 126 may assume that parameters (e.g., eCFI) in the ePCFICH in the first slot apply to the second slot in the subframe.

It should be noted that the UE 126 may recover separate ePCFICHs on separate layers (e.g., spatial streams). Control information corresponding to an ePCFICH may not have been pre-coded or may have been pre-coded with a pre-coding matrix common to a set of UEs 126 (e.g., all intended recipient UEs 126).

Each ePCFICH may carry one or more eCFIs. An eCFI may have a value ranging between 1 and a number n. Depending on the implementation, the unit (e.g., units or dimensions) of n may be based on a resource block, a resource element, a set (of m) consecutive resource elements or a fraction of a resource block as described above. In some implementations, the unit for n may vary in a semi-static way. For example, the UE 126 may receive Radio Resource Control (RRC) signaling from the eNB 102 that specifies the unit of n.

In some implementations, the UE operations module 138 may determine one or more ePDCCH regions based on the one or more eCFIs. For example, the UE operations module 138 may determine an ePDCCH region based on the one or more eCFIs in accordance with one or more of the approaches described above. The UE 126 may determine the one or more ePDCCH regions in order to recover one or more sets of DCI bits 108b (that are based on one or more Das generated and sent by the eNB 102, for example) included in the one or more ePDCCH regions.

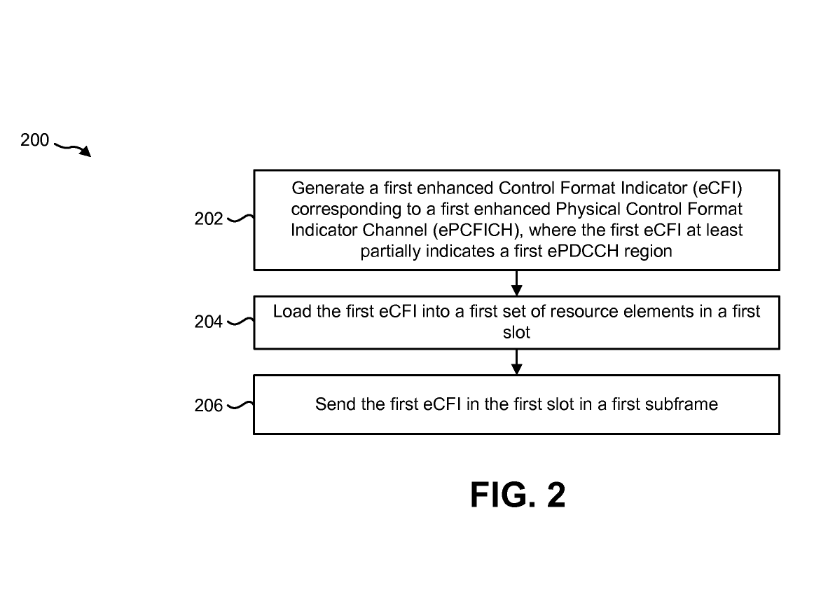

FIG. 2 is a flow diagram illustrating one configuration of a method 200 for indicating a control format. For example, FIG. 2 illustrates signaling an enhanced Control Format Indicator (eCFI) by an eNB 102. The eNB 102 may generate 202 a first eCFI corresponding to a first ePCFICH. The first eCFI generated 202 may at least partially indicate a first ePDCCH region. For instance, the first eCFI may independently indicate the ePDCCH region. Alternatively, the first eCFI may indicate the ePDCCH region in combination with another parameter sent via another kind of signaling, such as the system information signaling or RRC signaling as described in the approaches below.

The eNB 102 may load 204 the first eCFI into a first set of resource elements in a first slot. The first eCFI may be loaded initially across time resources and then across frequency resources in the first slot. For example, the eNB 102 may map the first eCFI corresponding to the first ePCFICH to a first set of resource elements. Some examples of the first set of resource elements may include a number of K resource elements at the beginning (e.g., the first K resource elements) of the slot, a number of K resource elements at the ending (e.g., the last K resource elements) of the slot, a dynamic cell-specific set of resource elements in the slot, a static cell-specific set of resource elements in the slot and a semi-static cell-specific set of resource elements in the slot.

The eNB 102 may send 206 the first eCFI in the first slot in a first subframe. For example, the eNB 102 may generate OFDM signals based on the first eCFI and send 206 the OFDM signals. As mentioned above, the first eCFI corresponding to the first ePCFICH may at least partially indicate a first ePDCCH region (e.g., the location and/or dimensions of an ePDCCH) in accordance with one or more of the approaches described above.

For clarity, several points are mentioned as follows. An ePCFICH is a channel. One or more resource elements in the time-frequency grid may be allocated for transmission of the ePCFICH. The content of ePCFICH may be referred to as one or more eCFIs.

The eNB 102 generates a bitstream that carries the information about the resources allocated for an ePDCCH. The bits generated by eNB 102 may be divided into those that are transmitted via ePCFICH and those that are transmitted by other procedures (e.g., other types of signaling). The bits that are going to be transmitted via the ePCFICH may be mapped into one or more eCFI. Each eCFI may be sent, carried and received on the ePCFICH. Control information corresponding to the ePCFICH is mapped into corresponding resources allocated for the transmission of the ePCFICH.

Accordingly, the eNB 102 generates a bitstream, which may be divided. A portion of the bitstream may be loaded into an eCFI and carried over the ePCFICH. Additionally, other portions of the bitstream may be signaled based on other types of signaling (e.g., static, semi-static, etc.). Resources (e.g., resource elements) may be allocated for the ePCFICH. The systems and methods disclosed herein in part describe how resources may be allocated for the ePCFICH.

In some implementations, the eNB 102 may optionally interleave bits corresponding to one or more eCFIs (e.g., eCFI bits 106a). Additionally or alternatively, the eNB 102 may optionally scramble the bits corresponding to the one or more eCFIs (e.g., eCFI bits 106a) with a scrambling sequence specific to a cell.

In some implementations, the eNB 102 may also send a signal that indicates an ePCFICH region. Examples of this signal include a system information signal (for static allocation), an RRC signal (for semi-static or semi-dynamic allocation) and PDCCH or ePDCCH common control signaling. In some implementations, the first set of resource elements may be a first DCI that the eNB 102 loads 204 into a common search space in the first slot.

In some implementations, the eNB 102 may generate a second eCFI corresponding to a second ePCFICH. The eNB 102 may load the second eCFI into a second set of resource elements in a second slot in the first subframe. In cases where the eNB 102 does not load a second eCFI corresponding to a second ePCFICH in a second slot, this may indicate that parameters in the first eCFI (e.g., one or more eCFIs) in the first slot should be applied to the second slot. Additionally sets of bits for additional slots may be generated in accordance with the systems and methods disclosed herein.

In some implementations, the eNB 102 may apply a random frequency offset to the first set of resource elements in the first slot. In cases where a second set of resource elements (e.g., a second ePCFICH) is loaded into a second slot, the eNB 102 may apply a random frequency offset to the first set of resource elements that is separate from (e.g., the same as or different from) a random frequency offset applied to the second set resource elements in the second slot. In some implementations, the eNB 102 may signal a random frequency offset (that is a cell-specific parameter). For example, the eNB 102 may send an RRC signal that indicates the random frequency offset.

In some implementations, the eNB 102 may map the first ePCFICH to resource elements on a first layer (on a first slot, for example) and a second ePCFICH to resource elements on a second layer (on the first slot in the second layer that may correspond to the first slot on the first layer, for example). The first ePCFICH may not be pre-coded or may be pre-coded based on a pre-coding matrix that is common to a set of UEs 126.

The first ePCFICH may include the first eCFI that has a value ranging between 1 and a number n. The unit of the number may be defined based on a resource block, a resource element, a set of x consecutive resource elements and a fraction of a resource block. The eNB 102 may generate 202 the first eCFI based on the definition of the unit of the number n. In some implementations, the unit of the number n may vary (in a semi-static way, for instance). For example, the eNB 102 may signal the unit of the number n through RRC signaling.

One of several approaches may be applied by the eNB 102 to indicate an ePDCCH to one or more UEs. More detail on these approaches and cases within the approaches are given above, but are briefly reviewed as follows. In a first approach, the eNB 102 may signal two parameters: the starting or ending point of an ePDCCH and the size of an ePDCCH. The eNB 102 may signal each of these two parameters by system information signaling (e.g., static configuration), RRC signaling (e.g., semi-static configuration) or through the one or more eCFIs generated 202 (e.g., dynamically).

In a first case of the first approach, the eNB 102 signals the starting or ending point of the ePDCCH by sending system information signaling. The eNB 102 may additionally signal the size of the ePDCCH (e.g., n) by sending system information signaling, RRC signaling or one or more generated 202 eCFIs carried by one or more ePCFICHs.

In a second case of the first approach, the eNB 102 signals the starting or ending point of the ePDCCH by RRC signaling. The eNB 102 may additionally signal the size of the ePDCCH (e.g., n) by sending system information signaling, RRC signaling or one or more generated 202 eCFIs carried by one or more ePCFICHs. In a third case of the first approach, the eNB 102 may signal both the starting or ending point of the ePDCCH and the size (e.g., n) of the ePDCCH by sending one or more generated 202 eCFIs carried by one or more ePCFICHs.

In a fourth case of the first approach, the eNB 102 signals the size of the ePDCCH by sending system information signaling. The eNB 102 may additionally signal the starting or ending point of the ePDCCH by sending RRC signaling or one or more generated 202 eCFIs carried by one or more ePCFICHs.

In a second approach, the eNB 102 may signal two parameters: the starting or ending point of an ePDCCH and a number of blind decoding candidates. The eNB 102 may signal each of these two parameters by system information signaling (e.g., static configuration), RRC signaling (e.g., semi-static configuration) or through one or more generated 202 eCFIs carried by one or more ePCFICHs (e.g., dynamically).

In a first case of the second approach, the eNB 102 signals the starting or ending point of the ePDCCH by sending system information signaling. The eNB 102 may additionally signal the number of blind decoding candidates by sending system information signaling, RRC signaling or one or more generated 202 eCFIs carried by one or more ePCFICHs.

In a second case of the second approach, the eNB 102 signals the starting or ending point of the ePDCCH by RRC signaling. The eNB 102 may additionally signal the number of blind decoding candidates by sending system information signaling, RRC signaling or one or more generated 202 eCFIs carried by one or more ePCFICHs. In a third case of the second approach, the eNB 102 may signal both the starting or ending point of the ePDCCH and the number of blind decoding candidates by sending one or more generated 202 eCFIs carried by one or more ePCFICHs.

In a fourth case of the second approach, the eNB 102 signals the number of blind decoding candidates by sending system information signaling. The eNB 102 may additionally signal the starting or ending point of the ePDCCH by sending RRC signaling or one or more generated 202 eCFIs carried by one or more ePCFICHs.

In a third approach, where an ePDSCH is one contiguous region, the eNB 102 may signal one parameter: the starting or ending point of an ePDSCH. The eNB 102 may signal this parameter by system information signaling (e.g., static configuration), RRC signaling (e.g., semi-static configuration) or through one or more generated 202 eCFIs carried by one or more ePCFICHs (e.g., dynamically).

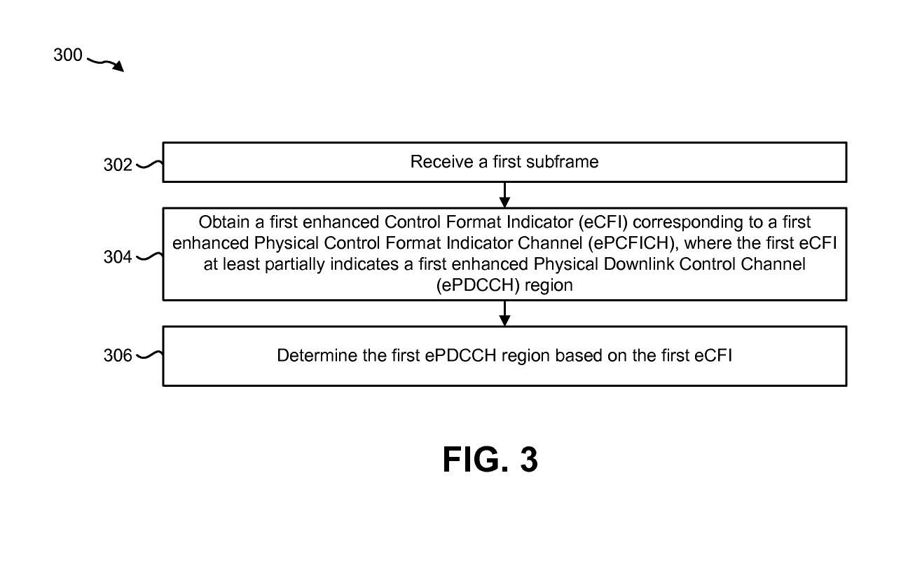

FIG. 3 is a flow diagram illustrating one configuration of a method 300 for determining a control format. For example, FIG. 3 illustrates signaling for an enhanced Physical Control Format Indicator Channel (ePCFICH) on a User Equipment (UE) 126. The UE 126 may receive 302 a first subframe. For example, the UE 126 may receive 302 OFDM signals that include the first subframe.

The UE 126 may obtain 304 a first eCFI corresponding to a first ePCFICH. The first eCFI obtained 304 may at least partially indicates a first ePDCCH region (e.g., resources allocated for transmission of an ePDCCH). For instance, the first eCFI may independently indicate the ePDCCH region. Alternatively, the first eCFI may indicate the ePDCCH region in combination with another parameter received via another kind of signaling, such as the system information signaling or RRC signaling as described in the approaches below. The first eCFI may be included in a first set of resource elements. The first set of resource elements may be located initially across time resources and then across frequency resources in a first slot of the first subframe.

The UE 126 may determine 306 the first ePDCCH region based on the first eCFI. For example, the UE 126 may interpret the first eCFI in accordance with one or more of the approaches described above in order to determine 306 the location and/or size of an ePDCCH region.

In some implementations, the UE 126 may optionally deinterleave bits corresponding to one or more eCFIs (e.g., eCFI bits). Additionally or alternatively, the UE 126 may optionally descramble the bits corresponding to the one or more eCFIs (e.g., eCFI bits).

In some implementations, the UE 126 may also receive a signal that indicates the location of the ePCFICH region. Examples of this signal include a system information signal (for static allocation), an RRC signal (for semi-static or semi-dynamic allocation) and PDCCH or ePDCCH common control signaling. The UE 126 may use this signal to determine the location of the first ePCFICH (e.g., the ePCFICH region). In some implementations, the first set of resource elements may be in a first DCI that the UE 126 may obtain from a common search space in the first slot.

In some implementations, the UE 126 may obtain a second eCFI corresponding to a second ePCFICH. The UE 126 may obtain the second eCFI from a second set of resource elements in a second slot in the first subframe. In cases where the UE 126 does not obtain a second eCFI corresponding to a second ePCFICH in a second slot, the UE 126 may apply parameters in the first eCFI in the first slot to the second slot.

In some implementations, the first set resource elements in the first slot may have a random frequency offset. In cases where a second eCFI corresponding to a second ePCFICH is obtained from a second slot, the first set resource elements may have a random frequency offset that is separate from (e.g., different from) a random frequency offset applied to the second set of resource elements in the second slot. In some implementations, the UE 126 may receive signaling that indicates a random frequency offset (that is a cell-specific parameter). For example, the UE 126 may receive an RRC signal that indicates the random frequency offset.

In some implementations, the UE 126 may obtain a first set of resource elements corresponding to the first ePCFICH from a first layer and a second set of resource elements corresponding to a second ePCFICH from a second layer. The first ePCFICH may not be pre-coded or may be pre-coded based on a pre-coding matrix that is common to a set of UEs 126.

The first ePCFICH may include the first eCFI that has a value ranging between 1 and a number n. The unit of the number may be defined based on a resource block, a resource element, a set of x consecutive resource elements and a fraction of a resource block. The UE 126 may interpret the first eCFI based on the definition of the unit of the number n. In some implementations, the unit of the number n may vary (in a semi-static way, for instance). For example, the UE 126 may determine the unit of the number n based on RRC signaling received from the eNB 102.

One of several approaches may be applied by the UE 126 to determine an ePDCCH. More detail on these approaches and cases within the approaches are given above, but are briefly reviewed as follows. In a first approach, the UE 126 may receive two parameters: the starting or ending point of an ePDCCH and the size of an ePDCCH. The UE 126 may receive each of these two parameters by system information signaling (e.g., static configuration), RRC signaling (e.g., semi-static configuration) or through the one or more obtained 304 eCFIs carried by one or more ePCFICHs (e.g., dynamically).

In a first case of the first approach, the UE 126 receives the starting or ending point of the ePDCCH by receiving system information signaling. The UE 126 may additionally receive the size of the ePDCCH (e.g., n) by receiving system information signaling, RRC signaling or one or more obtained 304 eCFIs carried by one or more ePCFICHs.

In a second case of the first approach, the UE 126 receives the starting or ending point of the ePDCCH by RRC signaling. The UE 126 may additionally receive the size of the ePDCCH (e.g., n) by receiving system information signaling, RRC signaling or one or more obtained 304 eCFIs carried by one or more ePCFICHs. In a third case of the first approach, the UE 126 may receive both the starting or ending point of the ePDCCH and the size (e.g., n) of the ePDCCH by receiving one or more obtained 304 eCFIs carried by one or more ePCFICHs.

In a fourth case of the first approach, the UE 126 receives the size of the ePDCCH by receiving system information signaling. The UE 126 may additionally receive the starting or ending point of the ePDCCH by receiving RRC signaling or one or more obtained 304 eCFIs carried by one or more ePCFICHs.

In a second approach, the UE 126 may receive two parameters: the starting or ending point of an ePDCCH and a number of blind decoding candidates. The UE 126 may receive each of these two parameters by system information signaling (e.g., static configuration), RRC signaling (e.g., semi-static configuration) or through the one or more obtained 304 eCFIs carried by one or more ePCFICHs (e.g., dynamically).

In a first case of the second approach, the UE 126 receives the starting or ending point of the ePDCCH by receiving system information signaling. The UE 126 may additionally receive the number of blind decoding candidates by receiving system information signaling, RRC signaling or one or more obtained 304 eCFIs carried by one or more ePCFICHs.

In a second case of the second approach, the UE 126 receives the starting or ending point of the ePDCCH by RRC signaling. The UE 126 may additionally receive the number of blind decoding candidates by receiving system information signaling, RRC signaling or one or more obtained 304 eCFIs carried by one or more ePCFICHs. In a third case of the second approach, the UE 126 may receive both the starting or ending point of the ePDCCH and the number of blind decoding candidates by receiving one or more obtained 304 eCFIs carried by one or more ePCFICHs.

In a fourth case of the second approach, the UE 126 receives the number of blind decoding candidates by receiving system information signaling. The UE 126 may additionally receive the starting or ending point of the ePDCCH by receiving RRC signaling or one or more obtained 304 eCFIs carried by one or more ePCFICHs.

In a third approach, where an ePDSCH is one contiguous region, the UE 126 may receive one parameter: the starting or ending point of an ePDSCH. The UE 126 may receive this parameter by system information signaling (e.g., static configuration), RRC signaling (e.g., semi-static configuration) or through the one or more obtained 304 eCFIs carried by one or more ePCFICHs (e.g., dynamically).

FIG. 4 is a block diagram illustrating one example of a slot 440. Each slot 440 (e.g., half of a subframe) may include N_{RB}N_{sc}^{RB} subcarriers 444 and a number of symbols N_{symb} 442 per subcarrier when a number of resource blocks 448 are allocated. A physical resource block 448 may include a number of resource elements 450 and may correspond to one slot 440 in the time domain and a number N_{sc}^{RB} of subcarriers 446 in the frequency domain. The number of symbols 442 (per subcarrier) may depend on a cyclic prefix. For example, some slots may include six symbols (per subcarrier) and some slots 440 may include seven symbols (per subcarrier 444) depending on the cyclic prefix. Each resource element 450 may be indicated by indexes k and l, where l is a symbol index and k is a subcarrier index.

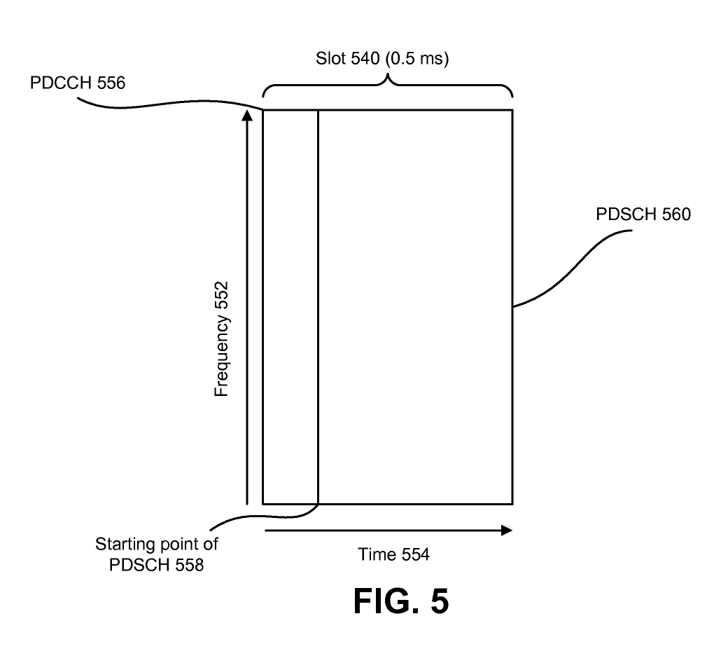

FIG. 5 is a block diagram illustrating another example of a slot 540. In particular, FIG. 5 illustrates allocation for control information and data in the first downlink slot 540 in accordance with Release 8-10 specifications. In this configuration, the slot 540 includes a PDCCH 556 (e.g., control information) and a PDSCH 560 (e.g., data). For example, the PDCCH 556 may be allocated along frequency 552 resources first and then along time 554 resources. For instance, one, two or three OFDM symbols may be allocated for the PDCCH 556. In this case, the remainder of the slot 540, from the starting point 558 of the PDSCH may include the PDSCH 560. As described above, this approach may be wasteful in cases that not all of the resources allocated for the PDCCH 556 are occupied (e.g., loaded with bits or symbols).

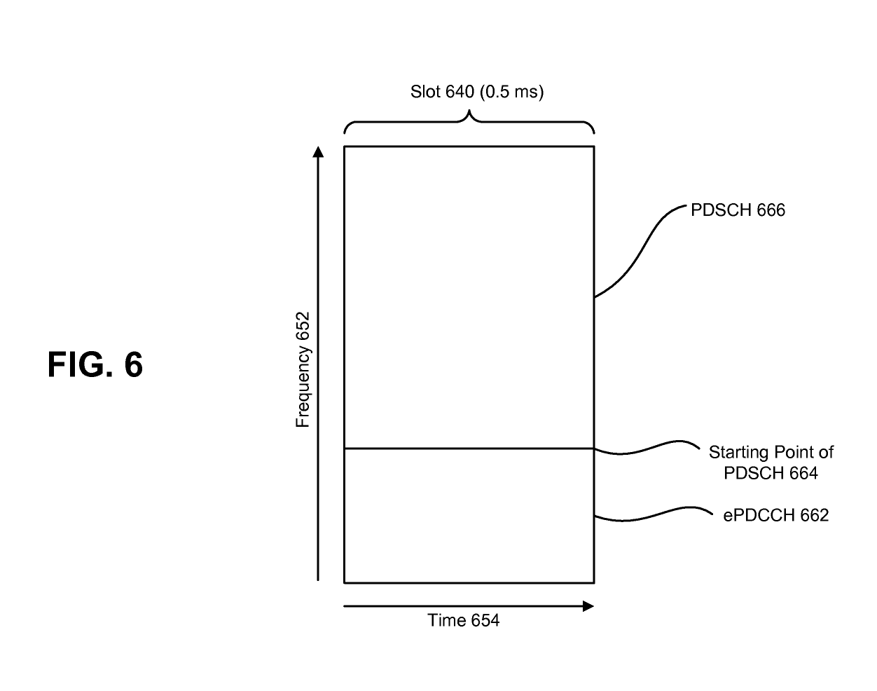

FIG. 6 is a block diagram illustrating another example of a slot 640. The systems and methods disclosed herein may provide an ePDCCH 662, which may operate in accordance with anticipated Release 11 specifications (and possibly beyond). In the ePDCCH 662, the entirety of an OFDM symbol may not be dedicated to control channel information, unlike in Release 8-10 specifications. In particular, FIG. 5 illustrates the conceptual allocation of control (e.g., PDCCH 556) and data (e.g., PDSCH 560) in accordance with 3GPP Release 8-10 specifications. In contrast, FIG. 6 illustrates a conceptual allocation of control information (e.g., ePDCCH 662) and data (e.g., PDSCH 666) for anticipated Release 11 specifications (and possibly beyond).

A dedicated component carrier known as an extension carrier may be applied specifically to Release 11 UEs. In other words, the extension carrier may not be backwards compatible with legacy UEs (e.g., UEs that operate in accordance with Release 8-10 specifications). For example, the ePDCCH 662 may be included in a dedicated non-backwards compatible component carrier known as the extension carrier. In this configuration, time 654 and frequency 652 resources may be allocated for control (e.g., ePDCCH 662) and data (e.g., PDSCH 666) as illustrated in FIG. 6. For example, the ePDCCH 662 may be loaded on time 654 resources first and then frequency 652 resources. Accordingly, the ePDCCH 662 may occupy the slot 640 up to the starting point 664 of the PDSCH 666. In some configurations, the ePDCCH 662 may extend through all the symbols in the time 654 domain (in a slot 640, for example) but may not extend through all the subcarriers in the frequency 652 domain.

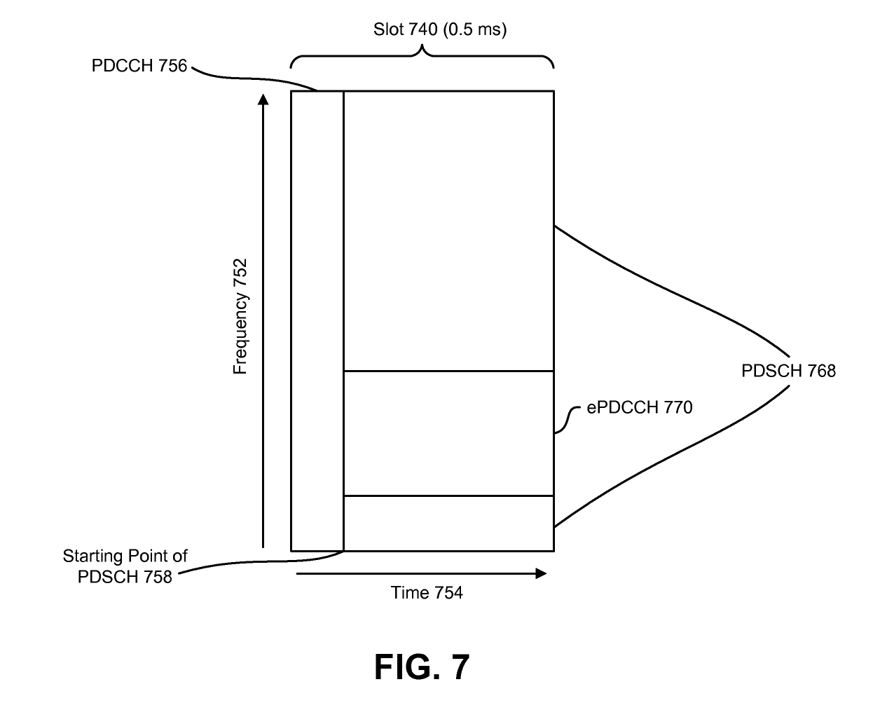

FIG. 7 is a block diagram illustrating another example of a slot 740. In particular, FIG. 7 illustrates a slot 740 over time 754 and frequency 752. In this example, the ePDCCH 770 may be transmitted in a component carrier (in an ePDCCH 770 region, for example) that also supports transmission of the PDCCH 756. In particular, FIG. 7 illustrates a PDCCH 756, an ePDCCH 770 and a PDSCH 768 in the slot 740.

Depending on the payload of the control the size of the ePDCCH 662, 770 (e.g., the number of resource elements occupied by the ePDCCH 662, 770), the number of subcarriers allocated to the ePDCCH 662, 770 may vary. It may be beneficial for all UEs that attempt to decode the ePDCCH 662, 770 to know the region (e.g., the boundaries of the region) allocated to the ePDCCH 662, 770. Knowing the ePDCCH 662, 770 region can determine the amount of blind decoding and the arrangement of Downlink Control Information (DCI) in the ePDCCH 662, 770. The ePDCCH 662, 770 may be determined (by a UE) based on the content of the enhanced (or extended) Physical Control Format Indicator Channel (ePCFICH). The content of the ePCFICH may be referred to as an enhanced (or extended) Control Format Indicator (eCFI). For clarity, the ePCFICH is a channel and the information content that is carried through the ePCFICH may be referred to as the eCFI.

If the ePDCCH 662 is allocated (according to the allocation illustrated in FIG. 6, for example) such that there is one contiguous Physical Downlink Shared Channel (PDSCH) 666, or enhanced (or extended) PDSCH (ePDSCH), then the ePDCCH 662 region may also be determined by the starting point 664 of the PDSCH 666 or ePDSCH. However, if the ePDCCH 770 divides the PDSCH 768 or ePDSCH into two disjoint partitions, then the starting point 758 of the PDSCH 768 or ePDSCH may not (by itself) determine the ePDCCH 770 region. It should be noted that the term ePDSCH may be used to refer to a shared channel that is linked to (e.g., associated with) the ePDCCH 770. Accordingly, there may be a distinction between the downlink resources (e.g., PDSCH) that are addressed by or linked to the PDCCH, and the downlink resources (e.g., ePDSCH) that are addressed by or linked to the ePDCCH.

FIG. 8 is a block diagram illustrating several examples of ways in which consecutive resource elements may be allocated. In particular, FIG. 8 illustrates slot A 840a and slot B 840b over frequency 852 and time 854. In a first example 872a, nine consecutive resource elements may be allocated by proceeding in an increasing direction across the time 854 dimension until the end of slot A 840a is reached, and then increasing by one subcarrier in the frequency 852 dimension and proceeding in a reversed (e.g., decreasing) direction in the time 854 dimension. In a second example 872b, nine consecutive resource elements may be allocated by proceeding in an increasing direction across the time 854 dimension until the end of slot A 840a is reached, and then increasing by one subcarrier in the frequency 852 dimension and proceeding in the same (e.g., increasing) direction in the time 854 dimension from the start of slot A 840a.

In a third example 872c, nine consecutive resource elements may be allocated by proceeding in an increasing direction across the frequency 852 dimension. In a fourth example 872d, nine consecutive resource elements may be allocated by proceeding in an increasing direction across the frequency dimension until the end of region A 874a is reached, and then increasing by one symbol in the time 854 dimension and proceeding in a reversed (e.g., decreasing) direction in the frequency 852 dimension and so forth. In a fifth example 872e, nine consecutive resource elements may be allocated by proceeding in an increasing direction across the frequency dimension until the end of region B 874b is reached, and then increasing by one symbol in the time 854 dimension and proceeding in the same (e.g., increasing) direction in the frequency 852 dimension and so forth.

FIG. 9 is a block diagram illustrating examples of enhanced Physical Control Format Indicator Channel (ePCFICH) resource allocation and symbol mapping. In particular, slot A 940a and slot B 940b are illustrated across time 954 and frequency 952 dimensions. Each slot 940a-b may include a number of resource elements 950 that may be allocated to bits or symbols corresponding to one or more ePCFICHs.

FIG. 9 illustrates ePCFICH regions 976a-b (allocated resources), cell-specific frequency offsets 980a-b as well as two scenarios (e.g., slot A 940a and slot B 940b) for symbol mapping. In slot A 940a, ePCFICH symbols A 978a are mapped along the time 954 axis first, whereas in slot B 940b, ePCFICH symbols B 978b are mapped along the frequency 952 axis first. In either case, if the ePCFICH symbols 978 cannot fill up the whole ePCFICH region 976, the remaining unfilled resource elements may be filled with dummy symbols, possibly representing Os, also known as zero-padding.

More specifically, slot A 940a may include ePCFICH region A 976a. Several resource elements 950 in ePCFICH region A 976a may be allocated for ePCFICH symbols A 978a (which may include or represent a set of bits). As illustrated in FIG. 9, ePCFICH symbols A 978a (e.g., X1, X2, X3, etc.) may be loaded into resource elements across the time 954 dimension first and then across the frequency 952 dimension. It should be noted that each ePCFICH region 976 may include one or more ePCFICHs 933. For example, ePCFICH region A 976a may include ePCFICH A 933a and ePCFICH B 933b. Each ePCFICH 933 may carry one or more eCFIs.

Slot B 940b may include ePCFICH region B 976b. Several resource elements 950 in ePCFICH region B 976b may be allocated for ePCFICH symbols B 978b (which may include or represent a set of bits). As illustrated in FIG. 9, ePCFICH symbols B 978b (e.g., X1, X2, X3, etc.) may be loaded into resource elements across the frequency 952 dimension first and then across the time 954 dimension.

Frequency offsets 980a-b are further illustrated in FIG. 9. A frequency offset 980 may specify a number of subcarriers in the frequency dimension 952 between the start of a slot 940 and an ePCFICH region 976. In accordance with the systems and methods herein, each slot 940 may have a separate frequency offset 980 applied to respective ePCFICHs. It should be noted that the separate frequency offsets between slots 940 may be the same or different. For example, frequency offset A 980a in slot A 940a is different from frequency offset B 980b in slot B 940b.

FIG. 9 also illustrates one example of a method 900 for generating and loading eCFIs. In this example, an eNB 102 may determine 923 an ePDCCH region. For example, the eNB 102 may determine 923 a resource allocation for an ePDCCH region.

The eNB 102 may generate 925 eCFI bits based on the ePDCCH region. For example, the eNB 102 may generate 925 eCFI bits that indicate the ePDCCH region.

The eNB 102 may generate 927 modulated symbols based on the eCFI bits. For instance, the eNB 102 may process, scramble, interleave, modulate and/or pre-code the eCFI bits, etc. to produce modulated symbols.

The eNB 102 may generate 929 one or more eCFIs. For example, an eCFI may include a sequence of one or more modulated symbols. The eNB 102 may also map 931 the one or more eCFIs to physical resources. In this example, ePCFICH symbols A 978a may include an eCFI comprising symbols X1, X2 and X3, etc.

Accordingly, FIG. 9 may illustrate the relationship among eCFI bits, an eCFI and an ePCFICH. A similar relationship may hold among DCI bits, DCI, and an ePDCCH. It should be noted that another eCFI and ePCFICH may be utilized in a case where there are multiple regions that cannot be identified with a single parameter (e.g., when each region has a different size).

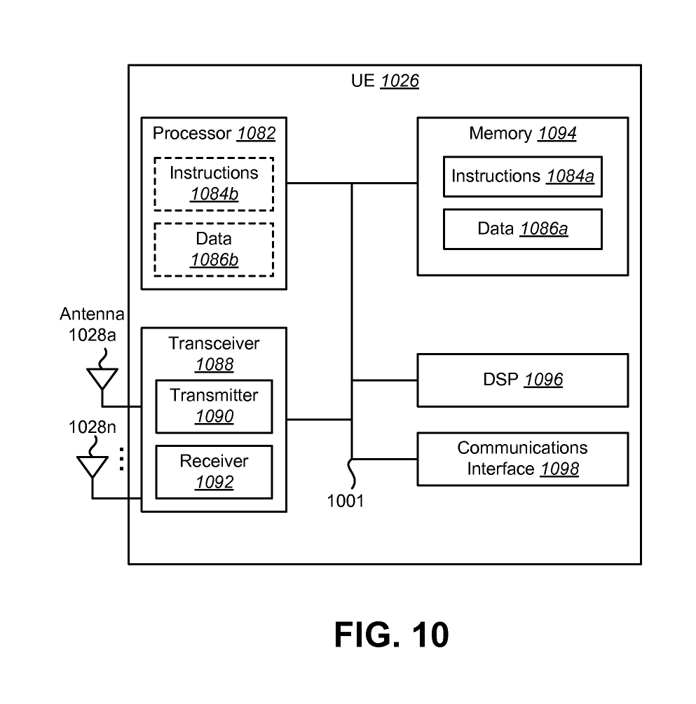

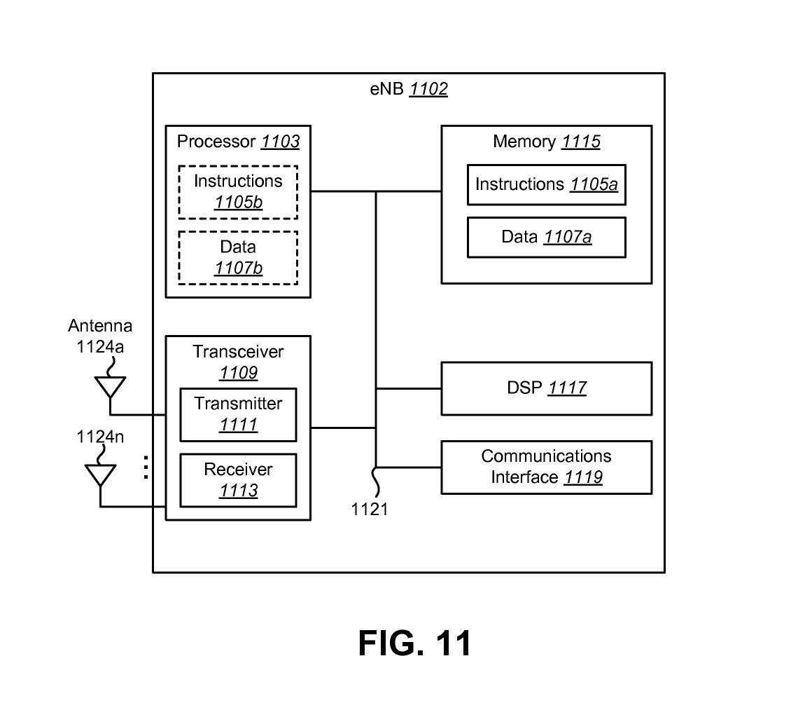

FIG. 10 illustrates various components that may be utilized in a User Equipment (UE) 1026. One or more of the UEs 126 described herein may be implemented in accordance with the UE 1026 described in connection with FIG. 11. The UE 1026 includes a processor 1082 that controls operation of the UE 1026. The processor 1082 may also be referred to as a central processing unit (CPU). Memory 1094, which may include read-only memory (ROM), random access memory (RAM), a combination of the two or any type of device that may store information, provides instructions 1084a and data 1086a to the processor 1082. A portion of the memory 1094 may also include non-volatile random access memory (NVRAM). Instructions 1084b and data 1086b may also reside in the processor 1082. Instructions 1084b and/or data 1086b loaded into the processor 1082 may also include instructions 1084a and/or data 1086a from memory 1094 that are loaded for execution or processing by the processor 1082. The instructions 1084b may be executed by the processor 1082 to implement the one or more of the method 300 and approaches described above.

The UE 1026 may also include a housing that contains one or more transmitters 1090 and one or more receivers 1092 to allow transmission and reception of data. The transmitter(s) 1090 and receiver(s) 1092 may be combined into one or more transceivers 1088. One or more antennas 1028a-n are attached to the housing and electrically coupled to the transceiver 1088.

The various components of the UE 1026 are coupled together by a bus system 1001, which may include a power bus, a control signal bus and a status signal bus, in addition to a data bus. However, for the sake of clarity, the various buses are illustrated in FIG. 10 as the bus system 1001. The UE 1026 may also include a digital signal processor (DSP) 1096 for use in processing signals. The UE 1026 may also include a communications interface 1098 that provides user access to the functions of the UE 1026. The UE 1026 illustrated in FIG. 10 is a functional block diagram rather than a listing of specific components.

FIG. 11 illustrates various components that may be utilized in an evolved Node B (eNB) 1102. One or more of the eNBs 102 described herein may be implemented in accordance with the eNB 1102 described in connection with FIG. 11. The eNB 1102 includes a processor 1103 that controls operation of the eNB 1102. The processor 1103 may also be referred to as a central processing unit (CPU). Memory 1115, which may include read-only memory (ROM), random access memory (RAM), a combination of the two or any type of device that may store information, provides instructions 1105a and data 1107a to the processor 1103. A portion of the memory 1115 may also include non-volatile random access memory (NVRAM). Instructions 1105b and data 1107b may also reside in the processor 1103. Instructions 1105b and/or data 1107b loaded into the processor 1103 may also include instructions 1105a and/or data 1107a from memory 1115 that are loaded for execution or processing by the processor 1103. The instructions 1105b may be executed by the processor 1103 to implement one or more of the method 200 and approaches described above.

The eNB 1102 may also include a housing that contains one or more transmitters 1111 and one or more receivers 1113 to allow transmission and reception of data. The transmitter(s) 1111 and receiver(s) 1113 may be combined into one or more transceivers 1109. One or more antennas 1124a-n are attached to the housing and electrically coupled to the transceiver 1109.

The various components of the eNB 1102 are coupled together by a bus system 1121, which may include a power bus, a control signal bus and a status signal bus, in addition to a data bus. However, for the sake of clarity, the various buses are illustrated in FIG. 11 as the bus system 1121. The eNB 1102 may also include a digital signal processor (DSP) 1117 for use in processing signals. The eNB 1102 may also include a communications interface 1119 that provides user access to the functions of the eNB 1102. The eNB 1102 illustrated in FIG. 11 is a functional block diagram rather than a listing of specific components.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An evolved Node B (eNB) for indicating a control format, comprising:
a processor;
memory in electronic communication with the processor;
instructions stored in the memory, the instructions being executable to:
generate a first enhanced Control Format Indicator (eCFI) corresponding to a first enhanced Physical Control Format Indicator Channel (ePCFICH), wherein the first eCFI at least partially indicates a first enhanced Physical Downlink Control Channel (ePDCCH) region;
load the first eCFI into a first set of resource elements in a first slot; and
send the first eCFI in the first slot in a first subframe.

2. The eNB of claim 1, wherein the first set of resource elements are loaded initially across time resources and then across frequency resources in the first slot.

3. The eNB of claim 1, wherein the first set of resource elements comprises one of the group consisting of a number of resource elements at a beginning of the first slot, a number of resource elements at an ending of the first slot, a dynamic cell-specific set of resource elements in the first slot, a static cell-specific set of resource elements in the first slot and a semi-static cell-specific set of resource elements in the first slot.

4. The eNB of claim 1, wherein the instructions are further executable to interleave a first set of eCFI bits.

5. The eNB of claim 1, wherein the instructions are further executable to scramble a first set of eCFI bits with a scrambling sequence specific to a cell.

6. The eNB of claim 1, wherein the instructions are further executable to send at least one of the group consisting of system information signaling, Radio Resource Control (RRC) signaling, Physical Downlink Control Channel (PDCCH) common control signaling or ePDCCH common control signaling that indicates the first set of resource elements.

7. The eNB of claim 1, wherein the first ePCFICH is a first Downlink Control Information (DCI) in a common search space.

8. The eNB of claim 1, wherein the instructions are further executable to signal a random frequency offset by sending Radio Resource Control (RRC) signaling.

9. The eNB of claim 1, wherein the instructions are further executable to:
generate a second eCFI corresponding to a second ePCFICH; and
load the second eCFI into a second set of resource elements in a second slot in the first subframe.

10. The eNB of claim 9, wherein a first random frequency offset applied to the first ePCFICH is separate from a second random frequency offset applied to the second ePCFICH.

11. The eNB of claim 1, wherein the instructions are further executable to:
map a second ePCFICH to a second layer on the first slot; and
map the first ePCFICH to a first layer on the first slot, wherein the first ePCFICH is not pre-coded or the first ePCFICH is pre-coded based on a pre-coding matrix that is common to a set of User Equipments (UEs).

12. The eNB of claim 1, wherein the first eCFI has a value ranging between 1 and a number, and wherein a unit of the number is defined based on one of the group consisting of a resource block, a resource element, a set of consecutive resource elements and a fraction of a resource block.

13. The eNB of claim 12, wherein the instructions are further executable to signal the unit of the number.

14. A User Equipment (UE) for determining a control format, comprising:
a processor;
memory in electronic communication with the processor;
instructions stored in the memory, the instructions being executable to:
receive a first subframe;
obtain a first enhanced Control Format Indicator (eCFI) corresponding to a first enhanced Physical Control Format Indicator Channel (ePCFICH), wherein the first eCFI at least partially indicates a first Physical Downlink Control Channel (ePDCCH) region; and
determine the ePDCCH region based on the first eCFI.

15. The UE of claim 14, wherein if the UE does not obtain a second eCFI corresponding to a second ePCFICH in a second slot, then the instructions are further executable to apply parameters in the first eCFI in a first slot to the second slot.

16. A method for indicating a control format by an evolved Node B (eNB), comprising:
generating a first enhanced Control Format Indicator (eCFI) corresponding to a first enhanced Physical Control Format Indicator Channel (ePCFICH), wherein the first eCFI at least partially indicates a first enhanced Physical Downlink Control Channel (ePDCCH) region;
loading the first eCFI into a first set of resource elements in a first slot; and
sending the first eCFI in the first slot in a first subframe.

17. The method of claim 16, wherein the first set of resource elements are loaded initially across time resources and then across frequency resources in the first slot.

18. The method of claim 16, wherein the first set of resource elements comprises one of the group consisting of a number of resource elements at a beginning of the first slot, a number of resource elements at an ending of the first slot, a dynamic cell-specific set of resource elements in the first slot, a static cell-specific set of resource elements in the first slot and a semi-static cell-specific set of resource elements in the first slot.

19. The method of claim 16, further comprising interleaving a first set of eCFI bits.

20. The method of claim 16, further comprising scrambling a first set of eCFI bits with a scrambling sequence specific to a cell.

21. The method of claim 16, further comprising sending at least one of the group consisting of system information signaling, Radio Resource Control (RRC) signaling, Physical Downlink Control Channel (PDCCH) common control signaling or ePDCCH common control signaling that indicates the first set of resource elements.

22. The method of claim 16, wherein the first ePCFICH is a first Downlink Control Information (DCI) in a common search space.

23. The method of claim 16, further comprising signaling a random frequency offset by sending Radio Resource Control (RRC) signaling.

24. The method of claim 16, further comprising:
generating a second eCFI corresponding to a second ePCFICH; and
loading the second eCFI into a second set of resource elements in a second slot in the first subframe.

25. The method of claim 24, wherein a first random frequency offset applied to the first ePCFICH is separate from a second random frequency offset applied to the second ePCFICH.

26. The method of claim 16, further comprising:
mapping a second ePCFICH to a second layer on the first slot; and
mapping the first ePCFICH to a first layer on the first slot, wherein the first ePCFICH is not pre-coded or the first ePCFICH is pre-coded based on a pre-coding matrix that is common to a set of User Equipments (UEs).

27. The method of claim 16, wherein the first eCFI has a value ranging between 1 and a number, and wherein a unit of the number is defined based on one of the group consisting of a resource block, a resource element, a set of consecutive resource elements and a fraction of a resource block.

28. The method of claim 27, further comprising signaling the unit of the number.

29. A method for determining a control format on a User Equipment (UE), comprising:
receiving a first subframe;
obtaining a first enhanced Control Format Indicator (eCFI) corresponding to a first enhanced Physical Control Format Indicator Channel (ePCFICH), wherein the first eCFI at least partially indicates a first Physical Downlink Control Channel (ePDCCH) region; and
determining the ePDCCH region based on the first eCFI.

30. The method of claim 29, wherein if a second eCFI corresponding to a second ePCFICH in a second slot is not obtained, then the method further comprises applying parameters in the first eCFI in a first slot to the second slot.
